(19) United States
(12) Patent Application Publication
(10) Pub. No.: US 2016/0082450 A1
(43) Pub. Date: Mar. 24, 2016

(54) Foam dispensing device utilizing spongy insert

(71) Applicant: Calvin Grant, Oak Park, IL (US)

(72) Inventor: Calvin Grant, Oak Park, IL (US)

(21) Appl. No.: 14/121,561

(22) Filed: Sep. 18, 2014

(51) Int. Cl. B05B 7/00; B05B 11/04

(52) U.S. Cl. CPC B05B 7/0018; B05B 11/047

(57) ABSTRACT

A foam dispensing device is comprised of a collapsible container and a spongy foam-producing insert. The container consists of a holding section, a dispensing section, and a dispensing orifice. It is filled with a foamable liquid, and, when it is compressed, the foamable liquid is pushed through the foam producing means and exits the orifice as foam. Also claimed is an embodiment of the invention wherein a second solution is stored in the spongy material and dissolved as the foamable liquid is expelled from the container. This device allows for a more simplistic and inexpensive system to deliver foam stored as a foamable liquid. The design also lends itself to be used for various medical applications, especially in ophthalmology.

### CROSS REFERENCE TO RELATED APPLICATIONS

Not applicable.

### STATEMENT REGARDING FEDERALLY SPONSORED RESEARCH AND DEVELOPMENT

Not applicable.

### REFERENCE TO AN APPENDIX

Not applicable.

### BACKGROUND OF THE INVENTION

This invention relates to a foam dispenser, for use particularly, but not exclusively, to generate a foamed ophthalmic solution from a foamable liquid solution and air.

A foam can be defined as a relatively large amount of a gas phase dispersed throughout a thin film of liquid. Foam dispensing devices consist of a means to agitate a foamable liquid and gas to create this dispersion, and a means to dispense the foam. Numerous foam dispensing devices have been published in patents and are available commercially.

The present invention is concerned with foam dispensing devices that utilize a deformable mixing reservoir, rather than those which supply a channel of pressurized air to a foamable liquid. This former type of device typically consists of a foam producing attachment, such as a sieved or porous attachment, connected to a deformable liquid storage reservoir. Air return to the reservoir is typically accomplished with a dip tube. Such designs require a high number of components which results in more complicated production and potentially higher manufacturing costs. U.S. Pat. No. 3,985,271, issued to Glassrock Products, Inc. in 1976, discloses a device of this nature. It includes a deformable reservoir to push a foamable liquid through a foam producing attachment involving a ball and check system. Also see U.S. Pat. No. 3,422,993, issued to Johnson & Son Inc. in 1969; U.S. Pat. No. 5,064,103, issued to RJS Industries, Inc in 1991; and U.S. Pat. No. 2,549,258, issued to Fred Stover in 1951.

Rather than an attachment, other conventional devices employ a sponge placed in the reservoir as the foam producing means. In these cases, the sponge must be squeezed multiple times to produce the foam with little fine control over the amount of liquid being converted. Such designs make creating and dispensing only the intended amount of foam difficult. Thus, if the device is stored, some of the liquid is unavoidably stored as foam. These devices could also be improved with regards to the consistency of the foam being produced. One such sponge employing device is U.S. Pat. No. 3,010,613, issued to Ernest Stossel in 1961. This patent discloses several sponge-valve systems which consist of a sponge held in a container by shredded plastic. Most of the devices must be submerged in liquid to operate. On top of the problems listed above, the shredded plastic cannot hold the sponge in one position. Other sponge-employing devices require a large number of parts. The devices in U.S. Pat. No. 6,547,063, issued to The Proctor and Gamble Company in 2003, consists of multiple elements, such as the temperature changing apparatus and two sponges.

Thus, there remains a need for a device with a simplistic design that consists of a small number of individual parts. A device capable of delivering small, consistent, uniform aliquots of a foamable solution with a closed storage means would also be valuable. Such a device would be especially useful in the field of ophthalmology. The ability to deliver small amounts of a solution of uniform consistency is important when delivering a prescribed aliquot of an ophthalmic solution. A simple design creates ease of use and decreased costs for a potential patient, especially when it is disposable. Furthermore, the ability to store the liquid with minimized contamination risks mitigates the risk of a potential infection.

### SUMMARY OF THE INVENTION

The object of the present invention is to provide a foam dispensing device with a more simplistic, cost-effective design.

Another object is to provide a device which is capable of delivering small aliquots of a foamable solution of uniform consistency.

Yet another object is to provide a device with closed, effective storage.

Yet another object is to provide an embodiment of the device with the above qualities, but with an additional feature also valuable in ophthalmic applications: the ability to mix two separately stored solutions as they are being converted to foam.

To solve the listed problems and accomplish the objectives, an invention is described that consists of a relatively small compressible bottle which has a protruding dispensing section on one end, and, located on the dispensing section, a small dispensing orifice. The dispensing section is a protruding portion on one end of the bottle and is of a smaller cross sectional area than the body of the bottle. A spongy material is attached to the inner surface of this device, which provides a means for a foamable liquid to be converted into foam. Fine control of sponge quality of the spongy material is achieved through modulation of its porosity.

In use, the bottle is filled with a foamable liquid and compressed, so that the liquid is pushed through the spongy material. While the liquid is in the sponge, it is mixed with air in the correct foam-producing ratio. It is then dispensed through the orifice as foam.

The spongy material can be a single corrugated piece of silicone or any piece of porous material that offers modulation of pore size. This could include various types of sponge-like polymers and composites, or any material that allows control of pore size and has a sponge-like structure. The modulation of porosity allows for fine control of sponge quality, and therefore a high level of control over the consistency of the foam being produced. The spongy material and pore size should prevent liquid from leaking out of the orifice when the container is inverted.

The sponge can range from having a smaller size that only occupies the dispensing section, to a larger size that occupies the entire inside volume of the bottle. However, the spongy material must be large enough to fill a cross section of the dispensing section in order to inhibit liquid from being pushed through the orifice during compression of the bottle. The spongy material is either fitted to the inside of the container, or attached to the inside edges with any non-reactive adhesive.

In another embodiment of the present invention, a second solution, to be mixed with the foamable liquid solution in the body, can be dissolved in the spongy insert. This solution is added to the sponge in whatever volume is necessary to create the ideal mixing ratio with the foamable liquid stored in the body. In use, as the container is squeezed, the foamable liquid in the body will be forced into the sponge and will react with the liquid dissolved in the sponge. The product of this reaction will then be converted into foam.

The present invention allows for a more simplistic and inexpensive system to deliver foam stored as a foamable liquid, and more control over the type of foam being dispensed. These qualities are especially useful in regards to ophthalmic applications. The design also includes a modification to mix the foaming solution with a second solution stored in the spongy material, a feature that is especially useful if the ophthalmic solution to be delivered is not easily foamable.

### BRIEF DESCRIPTION OF THE DRAWINGS

FIG. 1 shows the preferred embodiment of the invention.

FIG. 2 shows the embodiment of FIG. 1 containing a larger sponge assembled and in a vertical cross section.

FIG. 3 is an exploded view of the preferred embodiment of the invention with a larger sponge.

FIG. 4 shows an embodiment of FIG. 1 containing a smaller sponge assembled and in a vertical cross section.

FIG. 5 is an exploded view of the preferred embodiment of the invention with a smaller sponge.

### DETAILED DESCRIPTION OF THE PREFERRED EMBODIMENT

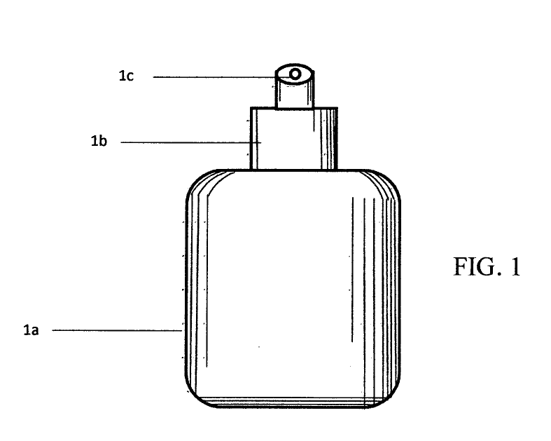

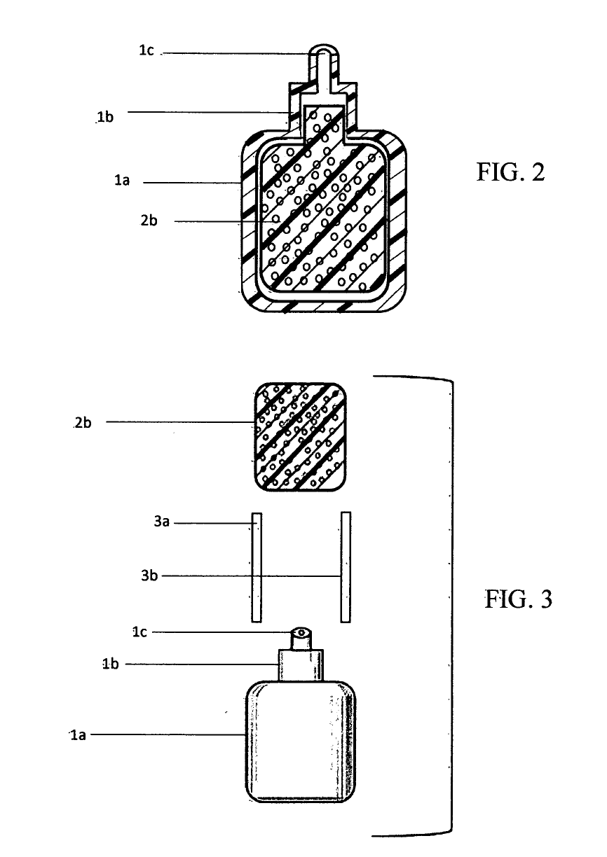

Referring to FIGS. 1-5, a compressible container 1 has a bottle shaped body 1a, a dispensing section 1b, and a dispensing orifice 1c. The dispensing section 1b protrudes from one end of the body 1a and has a smaller cross sectional area than the body 1a. The orifice 1c is a small hole located on the dispensing section 1b. The compressible container 1 also contains a spongy material 2, which is pictured in FIGS. 2-5.

In use, the compressible body of the container 1a will be filled with a foamable liquid 4, which is pictured in FIG. 2. The container will be compressed, which will push the foamable liquid 4 through the spongy material 2 and out of the dispensing orifice 1c.

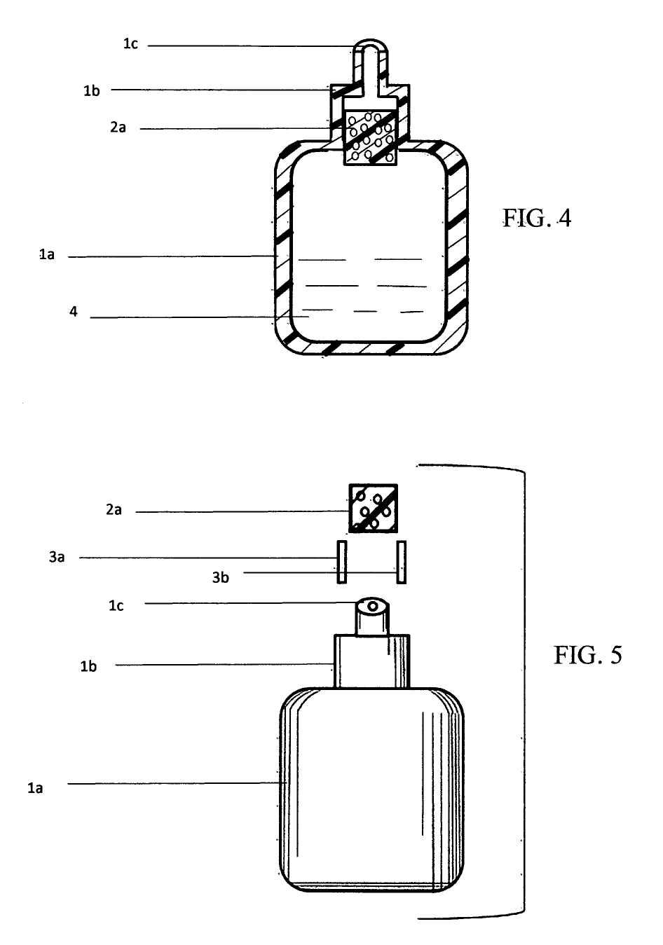

The spongy material can range from having a small size 2a that occupies only the inside space of the dispensing section, as is pictured in FIGS. 4 and 5, to a larger size 2b that occupies the entire inside space of the bottle, as is pictured in FIGS. 2 and 3. The spongy material 2 is either fitted to fill the bottle, or attached by any non-reactive adhesive material 3, which is pictured in the exploded views of FIGS. 3 and 5.

The spongy material 2 can be a single corrugated piece of silicone or any piece of porous material that allows modulation of pore size. This could include various types of sponge-like polymers and composites or any material with a sponge like structure that allows modulation of its pore size. The selected spongy material and pore size should prevent liquid from leaking out of the orifice when the container is inverted.

As described in the summary, in one embodiment of the device, a second solution is stored in the spongy material 2. When the container is compressed, the liquid in the holding section of the bottle is then forced in the sponge and either mixes or reacts with the liquid stored in the spongy material. The product is then dispensed through the orifice

Any foamable liquid can be packaged and dispensed in this container, but it is useful in particular for dispensing an ophthalmic solution or other medical solutions. It also provides the potential of being adapted to deliver measured aliquots of liquid or to mix two liquid solutions by storing one in the spongy material 2.

What is claimed is:

1. A foam dispensing device comprising:
a relatively small collapsible bottle consisting of a body to be filled with a liquid, a dispensing section, and a dispensing orifice, wherein the dispensing section is located on one end of the bottle, and the orifice is a small opening located on the dispensing section;
a piece of spongy material, which is secured to the inner surface of said bottle and fills a horizontal cross section of the area under the orifice.

2. The dispenser according to claim 1, wherein the dispensing section is a protruding portion of the bottle of a smaller horizontal cross section.

3. The dispenser according to claim 2, wherein the spongy material is a single corrugated piece of silicone or any porous medium that offers modulation of pore size.

4. The dispenser according to claim 3, wherein the spongy material is either fitted to fill the bottle or attached by any non-reactive adhesive material.

5. The dispenser according to claim 4, wherein the spongy material can range from having a small size that occupies only the inside space of the dispensing section, to a larger size that occupies the entire inside space of the bottle.

6. The dispenser according to claim 5, further including a second liquid, separate from the foamable liquid in the body, dissolved in the spongy material.
